(19) United States
(12) Patent Application Publication
(10) Pub. No.: US 2007/0234104 A1
(43) Pub. Date: Oct. 4, 2007

(54) Computer platform setup configuration data backup handling method and system

(75) Inventors: Wh Shih, Taipei (TW); Chin-Fong Pan, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/391,906

(22) Filed: Mar. 28, 2006

(51) Int. Cl. G06F 11/00

(52) U.S. Cl. 714/6

(57) ABSTRACT

A computer platform setup configuration data backup handling method and system is proposed, which is designed for use in conjunction with a computer platform for providing the computer platform with a configuration data memory backup handling function, and which is characterized by the capability of making a backup copy of the setup configuration data stored in CMOS RAM (Complementary Metal Oxide Semiconductor, Random-Access Memory), such that in the event of a failure to the CMOS RAM, the backup copy of setup configuration data can be retrieved for initialization of the computer platform at startup. This feature allows the computer platform to be notwithstanding able to start up in the event of a failure to the CMOS RAM, thus allowing the computer platform having faulted CMOS RAM to be nevertheless operable to provide intended services without requiring the end user to ask for help from the manufacturer.

### BACKGROUND OF THE INVENTION

1. Field of the Invention

This invention relates to computer technology, and more particularly, to a computer platform setup configuration data backup handling method and system which is designed for use in conjunction with a computer platform of the type having a setup configuration data memory module, such as a CMOS RAM (Complementary Metal Oxide Semiconductor, Random-Access Memory) module, for providing the CMOS RAM module with a backup handling function that allows the computer platform to be notwithstanding able to be started up in the event of a failure to the CMOS RAM module.

2. Description of Related Art

CMOS RAM (Complementary Metal Oxide Semiconductor, Random-Access Memory) is a special type of memory that is battery-powered and installed on computer platforms, such as desktop computers, notebook computers, or network servers, for storing setup configuration data that is to be used for initialization of the computer platform at startup. Typically, the setup configuration data stored in a CMOS RAM includes current date and time (year/month/day/hour/minute/second), types of currently installed hard disk drives, memory capacity, port configuration, to name a few. When a computer platform is powered on, it will first retrieve the setup configuration data from the CMOS RAM for system initialization of the computer platform.

In the case of network servers, the end users often need to set custom-specified setup configuration data to the CMOS RAM of their network servers based on specific requirements in their network applications. However, since most end users are technically unfamiliar with CMOS RAM setting procedures, the custom-specified setup configuration data is typically set in factory by the manufacturer for the customer.

One drawback to the above-mentioned practice, however, is that when a failure occurs to the CMOS RAM or the setup configuration data stored therein is corrupted, it will cause the computer platform to be unbootable at startup; and when this happens, the customer often needs to ask the original manufacturer for help to fix the CMOS RAM problem. The process is undoubtedly quite laborious and time-consuming. Moreover, on the customer side, since the fixing of the CMOS RAM problem would typically take some time to complete on the manufacturer side, the faulted network server would be inoperable for a while until the CMOS RAM problem is fixed, which would undoubtedly affect the network services offered by the server.

### SUMMARY OF THE INVENTION

It is therefore an objective of this invention to provide a computer platform setup configuration data backup handling method and system which allows a network server to be notwithstanding able to be initialized at startup in the even of a failure to the CMOS RAM, without requiring the customer to ask the manufacturer for help.

The computer platform setup configuration data backup handling method and system according to the invention is designed for use in conjunction with a computer platform of the type having a setup configuration data memory module, such as a CMOS RAM (Complementary Metal Oxide Semiconductor, Random-Access Memory) module, for providing the CMOS RAM module with a backup handling function that allows the computer platform to be notwithstanding able to be started up in the event of a failure to the CMOS RAM module.

In conception, the computer platform setup configuration data backup handling method according to the invention comprises: (1) responding to each setup configuration data setting event on the setup configuration data memory unit by duplicating a copy of setup configuration data currently stored to the setup configuration data memory unit, and then storing the duplicated copy of setup configuration data as backup data into the programmable non-volatile memory unit; (2) responding to a setup configuration data failure event on the setup configuration data memory unit at startup of the computer platform by issuing a backup enable message; and (3) responding to the backup enable message from the setup configuration data failure responding module by retrieving the backup copy of setup configuration data from the programmable non-volatile memory unit for use by the startup control unit for initialization of the computer platform.

In architecture, the computer platform setup configuration data backup handling system according to the invention comprises: (A) a setup configuration data backup module, which is capable of responding to each setup configuration data setting event on the setup configuration data memory unit by duplicating a copy of setup configuration data currently stored to the setup configuration data memory unit and then storing the duplicated copy of setup configuration data as backup data into the programmable non-volatile memory unit; (B) a setup configuration data failure responding module, which is capable of responding to a setup configuration data failure event on the setup configuration data memory unit at startup of the computer platform by issuing a backup enable message; and (C) a backup data retrieving module, which is capable of responding to the backup enable message from the setup configuration data failure responding module by retrieving the backup copy of setup configuration data from the programmable non-volatile memory unit for use by the startup control unit for initialization of the computer platform.

The computer platform setup configuration data backup handling method and system according to the invention is characterized by the capability of making a backup copy of the setup configuration data stored in the CMOS RAM and storing the backup data in a programmable non-volatile memory unit, such that in the event of a failure to the CMOS RAM, the backup copy of setup configuration data can be retrieved from the programmable non-volatile memory unit for initialization of the computer platform at startup. This feature allows the computer platform to be notwithstanding able to start up in the event of a failure to the CMOS RAM, without requiring the end user to ask for help from the manufacturer.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer platform setup configuration data backup handling system of the invention in conjunction with a computer platform; and

FIG. 2 is a schematic diagram showing an object-oriented component model for the computer platform setup configuration data backup handling system of the invention.

### DETAILED DESCRIPTION OF PREFERRED EMBODIMENTS

The computer platform setup configuration data backup handling method and system according to the invention is disclosed in full details by way of preferred embodiments in the following with reference to the accompanying drawings.

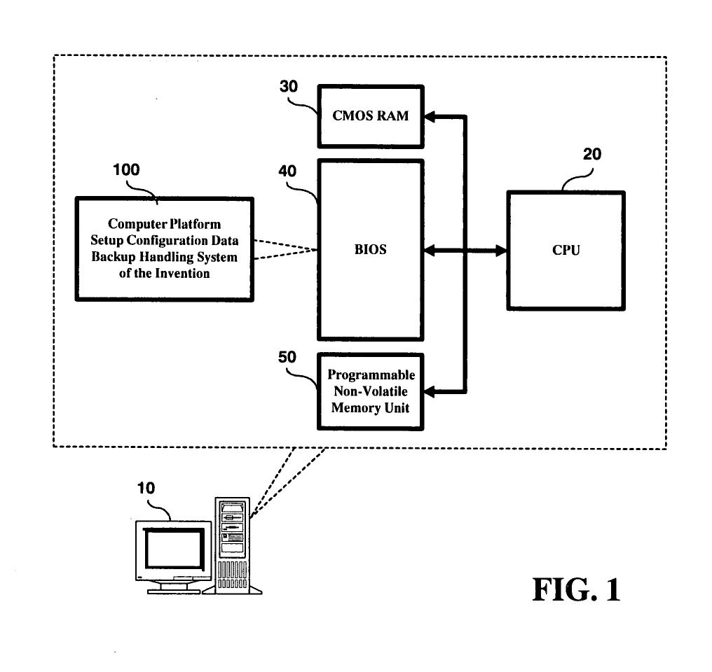

FIG. 1 is a schematic diagram showing the application of the computer platform setup configuration data backup handling system according to the invention (which is here encapsulated in a block indicated by the reference numeral 100). As shown, the computer platform setup configuration data backup handling system of the invention 100 is designed for use in conjunction with a computer platform 10, such as a network server, a desktop computer, or a notebook computer, that is equipped with a CPU (Central Processing Unit) 20, a setup configuration data memory unit 30, a startup control unit 40, and a programmable non-volatile memory unit 50; where the setup configuration data memory unit 30 is for example a CMOS RAM (Complementary Metal Oxide Semiconductor, Random-Access Memory) module; the startup control unit 40 is for example a BIOS (Basic Input/Output System) module; and the programmable non-volatile memory unit 50 is for example a flash memory module.

In actual application, the computer platform setup configuration data backup handling system of the invention 100 is capable of allowing the computer platform 10 to be notwithstanding able to boot up in the event of a failure to the CMOS RAM module 30.

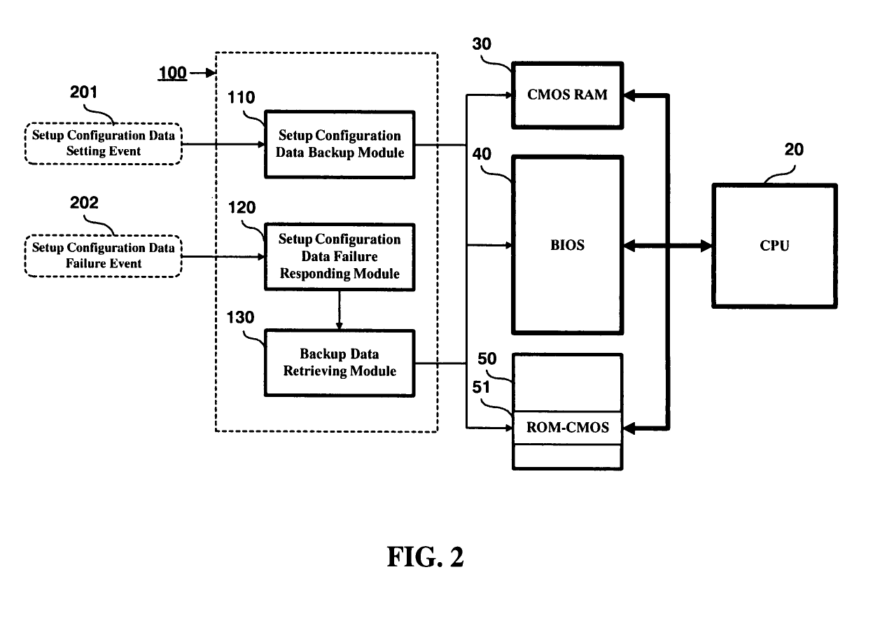

As shown in FIG. 2, in architecture, the computer platform setup configuration data backup handling system of the invention 100 is based on an object-oriented component model which comprises: (A) a setup configuration data backup module 110; (B) a setup configuration data failure responding module 120; and (C) a backup data retrieving module 130. In practical implementation, the computer platform setup configuration data backup handling system of the invention 100 can be fully realized by computer code and integrated as an add-on firmware module to the BIOS (Basic Input/Output System) of the computer platform 10, such that the computer code can be executed by the CPU 20 to provide a backup handling function for the computer platform 10.

Firstly, the respective attributes and behaviors of these constituent components 110, 120, 130 of the computer platform setup configuration data backup handling system of the invention 100 are described in details in the following

The setup configuration data backup module 110 is capable of responding to each setup configuration data setting event 201 on the CMOS RAM module 30 (i.e., in the event of a set of setup configuration data being set by the manufacturer or user to the CMOS RAM module 30) by duplicating a copy of the setup configuration data currently stored to the CMOS RAM module 30 and then storing the duplicated copy of setup configuration data as backup data into a predefined storage area 51 (hereinafter referred to as “backup setup configuration data storage area” and denoted by ROM-CMOS) in the programmable non-volatile memory unit 50. In practical implementation, for example, the programmable non-volatile memory unit 50 can be either a flash memory module used for storing BIOS code (a memory space of the BIOS module 40) or a separate flash memory unit appended to the BIOS module 40.

The setup configuration data failure responding module 120 is capable of responding to a setup configuration data failure event 202 on the CMOS RAM module 30 (i.e., in the event of a failure to the CMOS RAM module 30) at startup of the computer platform 10 by issuing a backup enable message to the backup data retrieving module 130.

The backup data retrieving module 130 is capable of responding to the backup enable message from the setup configuration data failure responding module 120 by retrieving the backup copy of setup configuration data stored in the ROM-CMOS area 51 of the programmable non-volatile memory unit 50 for use by the BIOS module 40 for initialization of the computer platform 10.

The following is a detailed description of a practical application example of the computer platform setup configuration data backup handling system of the invention 100 during actual operation.

Referring to FIG. 1 together with FIG. 2, in actual operation, whenever a user (customer or manufacturer) inputs a set of setup configuration data to the CMOS RAM module 30, it initiates a setup configuration data setting event 201 which causes the setup configuration data backup module 110 to respond by duplicating a copy of the user-defined setup configuration data currently stored to the CMOS RAM module 30 and then storing the duplicated copy of setup configuration data as backup data into the ROM-CMOS area 51 of the programmable non-volatile memory unit 50.

Afterwards, whenever the computer platform 10 is powered on, if the setup configuration data stored in the CMOS RAM module 30 is uncorrupted and good for use, the BIOS module 40 will retrieve the setup configuration data from the CMOS RAM module 30 for initialization of the computer platform 10.

On the other hand, if the setup configuration data stored in the CMOS RAM module 30 is corrupted (i.e., a setup configuration data failure event 202 occurs), it will cause the setup configuration data failure responding module 120 to respond by issuing a backup enable message to the backup data retrieving module 130, thereby activating the backup data retrieving module 130 to retrieve the backup copy of setup configuration data stored in the ROM-CMOS area 51 of the programmable non-volatile memory unit 50 for use by the BIOS module 40 for initialization of the computer platform 10. This allows the computer platform 10 to be notwithstanding able to start up successfully even though the setup configuration data stored in the CMOS RAM module 30 is corrupted.

During the foregoing procedure, if the backup setup configuration data stored in the ROM-CMOS area 51 or the programmable non-volatile memory unit 50 is also corrupted, then the BIOS module 40 can nevertheless utilize a default set of setup configuration data stored elsewhere for the initialization of the computer platform 10 at startup.

In conclusion, the invention provides a computer platform setup configuration data backup handling method and system for use with a computer platform for providing the computer platform with a setup configuration data backup handling function, which is characterized by the capability of making a backup copy of the setup configuration data stored in the CMOS RAM and storing the backup data in a programmable non-volatile memory unit, such that in the event of a failure to the CMOS RAM, the backup copy of setup configuration data can be retrieved from the programmable non-volatile memory unit for initialization of the computer platform at startup. This feature allows the computer platform to be notwithstanding able to start up in the event of a failure to the CMOS RAM, without requiring the end user to ask for help from the manufacturer. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform setup configuration data backup handling method for use on a computer platform of the type having a setup configuration data memory unit, a startup control unit, and a programmable non-volatile memory unit, for providing the setup configuration data memory unit with a backup handling function;
the computer platform setup configuration data backup handling method comprising:
responding to each setup configuration data setting event on the setup configuration data memory unit by duplicating a copy of setup configuration data currently stored to the setup configuration data memory unit, and then storing the duplicated copy of setup configuration data as backup data into the programmable non-volatile memory unit;
responding to a setup configuration data failure event on the setup configuration data memory unit at startup of the computer platform by issuing a backup enable message; and
responding to the backup enable message from the setup configuration data failure responding module by retrieving the backup copy of setup configuration data from the programmable non-volatile memory unit for use by the startup control unit for initialization of the computer platform.

2. The computer platform setup configuration data backup handling method of claim 1, wherein the computer platform is a network server.

3. The computer platform setup configuration data backup handling method of claim 1, wherein the computer platform is a desktop computer.

4. The computer platform setup configuration data backup handling method of claim 1, wherein the computer platform is a notebook computer.

5. The computer platform setup configuration data backup handling method of claim 1, wherein the setup configuration data memory unit is a CMOS RAM (Complementary Metal Oxide Semiconductor, Random-Access Memory) module.

6. The computer platform setup configuration data backup handling method of claim 1, wherein the startup control unit is a BIOS (Basic Input/Output System) module.

7. The computer platform setup configuration data backup handling method of claim 1, wherein the programmable non-volatile memory unit is a flash memory module.

8. A computer platform setup configuration data backup handling system for use with a computer platform of the type having a setup configuration data memory unit, a startup control unit, and a programmable non-volatile memory unit, for providing the setup configuration data memory unit with a backup handling function;
the computer platform setup configuration data backup handling system comprising:
a setup configuration data backup module, which is capable of responding to each setup configuration data setting event on the setup configuration data memory unit by duplicating a copy of setup configuration data currently stored to the setup configuration data memory unit and then storing the duplicated copy of setup configuration data as backup data into the programmable non-volatile memory unit;
a setup configuration data failure responding module, which is capable of responding to a setup configuration data failure event on the setup configuration data memory unit at startup of the computer platform by issuing a backup enable message; and
a backup data retrieving module, which is capable of responding to the backup enable message from the setup configuration data failure responding module by retrieving the backup copy of setup configuration data from the programmable non-volatile memory unit for use by the startup control unit for initialization of the computer platform.

9. The computer platform setup configuration data backup handling system of claim 8, wherein the computer platform is a network server.

10. The computer platform setup configuration data backup handling system of claim 8, wherein the computer platform is a desktop computer.

11. The computer platform setup configuration data backup handling system of claim 8, wherein the computer platform is a notebook computer.

12. The computer platform setup configuration data backup handling system of claim 8, wherein the setup configuration data memory unit is a CMOS RAM (Complementary Metal Oxide Semiconductor, Random-Access Memory) module.

13. The computer platform setup configuration data backup handling system of claim 8, wherein the startup control unit is a BIOS (Basic Input/Output System) module.

14. The computer platform setup configuration data backup handling system of claim 8, wherein the programmable non-volatile memory unit is a flash memory module.
